(19) United States
(12) Patent Application Publication
(10) Pub. No.: US 2024/0185249 A1
(43) Pub. Date: Jun. 6, 2024

(54) EVALUATING TRANSACTIONS IN A DECENTRALIZED FINANCE NETWORK BASED ON DECOMPOSED NON-FUNGIBLE TOKENS (NFTs)

(71) Applicant: Bank of America Corporation, Charlotte, NC (US)

(72) Inventors: Naga Vamsi Krishna Akkapeddi, Charlotte, NC (US); Siten Sanghvi, Westfield, NJ (US)

(21) Appl. No.: 18/074,565

(22) Filed: Dec. 5, 2022

(51) Int. Cl. G06Q 20/40; G06Q 20/38

(52) U.S. Cl. CPC G06Q 20/4016; G06Q 20/389

(57) ABSTRACT

Aspects of the disclosure relate to evaluating transactions in a decentralized finance network based on decomposed non-fungible tokens (NFTs). A computing platform may analyze a consumer request and may transmit, to an enterprise organization computing device, a recommendation to either approve or reject the consumer request. The computing platform may analyze an assessment of an asset within the consumer request, and may generate an NFT that corresponds to the asset and a plurality of decomposed NFTs that correspond to components of the asset. The computing platform may determine a value of the asset based on the NFT and/or corresponding decomposed NFTs. The computing platform may establish a digital marketplace within which the NFTs and/or decomposed NFTs may be transferred, and may generate consumer data based on querying the digital marketplace. The computing platform may evaluate additional consumer requests based on the generated consumer data.

### BACKGROUND

Aspects of the disclosure relate to hardware and/or software for evaluating transactions in a decentralized finance network based on decomposed non-fungible tokens (NFTs). In particular, one or more aspects of the disclosure may relate to generating a digital rendering (e.g., a non-fungible token (NFT)) that corresponds to an asset and/or a decomposed NFT that corresponds to a component of the asset, monitoring an appreciation and/or depreciation of the asset based on analyzing each component therein, and evaluating additional consumer requests using a net worth corresponding to a consumer computing device based on analyzing NFTs associated with the consumer computing device.

Current financial transaction processing methods within a decentralized finance network may permit a consumer computing device to transmit, to an enterprise organization, a request to acquire an asset (e.g., a commercial property, a residential property, an automobile, or the like). Based on receiving lending authorization from at least one of the enterprise organization and/or an external lending entity, the consumer computing device may obtain ownership of the asset, which may be recorded through physical media. The enterprise organization may monitor (e.g., for a pre-determined amount of time, or the like) a value of the asset and may determine whether the value of the asset may appreciate and/or depreciate over time based on analyzing the value of the entirety of the asset. However, the enterprise organization might not consider individual features of the asset and/or how the appreciation and/or depreciation of the individual features may affect the value of the asset.

Moreover, current financial transaction processing methods may encourage enterprise organizations to monitor asset ownership and/or transfers of asset ownership through physical media. In doing so, the enterprise organization and/or the consumer associated with the asset may need to acquire and distribute the physical media to all parties involved, which may compromise an efficiency of an acquisition and/or transfer of ownership process. Furthermore, reliance on the physical media might not promote transparency throughout the acquisition and/or transfer of ownership processes since at least one party involved may withhold documentation. Therefore, current financial transaction processing methods and current financial transaction analyses might not permit enterprise organizations to deconstruct the asset into a plurality of components, generate an NFT (and/or a decomposed NFT) that corresponds to each asset and/or each component therein, detect an appreciation and/or depreciation of the value of the asset based on monitoring the NFT (and/or decomposed NFTs) associated with each component, and/or evaluate additional consumer requests based on analyzing a totality of NFTs associated with the consumer computing device.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, and convenient technical solutions that address and overcome the technical problems associated with evaluating, in real-time or near real-time, transactions in a decentralized finance network based on decomposed non-fungible tokens (NFTs).

In accordance with one or more embodiments, a method may comprise, at a computing device including one or more processors and memory, receiving, from an enterprise organization computing device, a consumer request and instructions to analyze the consumer request. The method may comprise analyzing the consumer request. The method may comprise generating, based on the analyzing the consumer request, a recommendation on whether to approve the consumer request. The method may comprise transmitting, to the enterprise organization computing device, the recommendation. The method may comprise receiving, from the enterprise organization computing device, instructions to analyze an assessment of an asset, of a plurality of assets, associated with the consumer request. The method may comprise analyzing, based on analyzing the assessment, a plurality of components of the asset. The method may comprise generating a plurality of non-fungible tokens (NFTs), wherein each NFT corresponds to a different asset of the plurality of assets. The method may comprise generating a plurality of decomposed NFTs, wherein each decomposed NFT corresponds to, for each asset of the plurality of assets, a different component of the plurality of components of the asset. The method may comprise determining, based on analyzing the plurality of components of the asset, a value of the asset. The method may comprise determining, based on the value of the asset, consumer data that corresponds to a consumer computing device associated with the consumer request. The method may comprise evaluating a plurality of additional consumer requests, associated with the consumer computing device, based on the consumer data.

In accordance with one or more embodiments, a computing platform may comprise at least one processor, a communication interface communicatively coupled to the at least one processor, and memory storing computer-readable instructions that, when executed by the at least one processor, cause the computing platform to receive, from an enterprise organization computing device, a consumer request and instructions to analyze the consumer request. The computing platform may analyze the consumer request. The computing platform may generate, based on the analyzing the consumer request, a recommendation on whether to approve the consumer request. The computing platform may transmit, to the enterprise organization computing device, the recommendation. The computing platform may receive, from the enterprise organization computing device, instructions to analyze an assessment of an asset, of a plurality of assets, associated with the consumer request. The computing platform may analyze, based on analyzing the assessment, a plurality of components of the asset. The computing platform may generate a plurality of non-fungible tokens (NFTs), wherein each NFT corresponds to a different asset of the plurality of assets. The computing platform may generate a plurality of decomposed NFTs, wherein each decomposed NFT corresponds to, for each asset of the plurality of assets, a different component of the plurality of components of the asset. The computing platform may determine, based on analyzing the plurality of components of the asset, a value of the asset. The computing platform may determine, based on the value of the asset, consumer data that corresponds to a consumer computing device associated with the consumer request. The computing platform may evaluate a plurality of additional consumer requests, associated with the consumer computing device, based on the consumer data.

In accordance with one or more embodiments, one or more non-transitory computer-readable media storing instructions that, when executed by a computing platform comprising at least one processor, memory, and a communication interface, cause the computing platform to receive, from an enterprise organization computing device, a consumer request and instructions to analyze the consumer request. The instructions, when executed, may cause the computing platform to analyze the consumer request. The instructions, when executed, may cause the computing platform to generate, based on the analyzing the consumer request, a recommendation on whether to approve the consumer request. The instructions, when executed, may cause the computing platform to transmit, to the enterprise organization computing device, the recommendation. The instructions, when executed, may cause the computing platform to receive, from the enterprise organization computing device, instructions to analyze an assessment of an asset, of a plurality of assets, associated with the consumer request. The instructions, when executed, may cause the computing platform to analyze, based on analyzing the assessment, a plurality of components of the asset. The instructions, when executed, may cause the computing platform to generate a plurality of non-fungible tokens (NFTs), wherein each NFT corresponds to a different asset of the plurality of assets. The instructions, when executed, may cause the computing platform to generate a plurality of decomposed NFTs, wherein each decomposed NFT corresponds to, for each asset of the plurality of assets, a different component of the plurality of components of the asset. The instructions, when executed, may cause the computing platform to determine, based on analyzing the plurality of components of the asset, a value of the asset. The instructions, when executed, may cause the computing platform to determine, based on the value of the asset, consumer data that corresponds to a consumer computing device associated with the consumer request. The instructions, when executed, may cause the computing platform to evaluate a plurality of additional consumer requests, associated with the consumer computing device, based on the consumer data.

These features, along with many others, are discussed in greater detail below.

### BRIEF DESCRIPTION OF THE DRAWINGS

The present disclosure is illustrated by way of example and is not limited in the accompanying figures in which like reference numerals indicate similar elements and in which:

FIG. 1A depicts an illustrative example of a computer system for evaluating transactions in a decentralized finance network based on decomposed non-fungible tokens (NFTs), in accordance with one or more example embodiments.

FIG. 1B depicts an illustrative example of a computing platform that may be used for evaluating transactions in a decentralized finance network based on decomposed non-fungible tokens (NFTs), in accordance with one or more example embodiments.

FIGS. 2A-2B depict an illustrative event sequence for evaluating transactions in a decentralized finance network based on decomposed non-fungible tokens (NFTs), in accordance with one or more example embodiments.

FIG. 3 depicts an illustrative method for evaluating transactions in a decentralized finance network based on decomposed non-fungible tokens (NFTs), in accordance with one or more example embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized, and structural and functional modifications may be made, without departing from the scope of the present disclosure. Various aspects are capable of other embodiments and of being practiced or being carried out in various different ways.

It is noted that various connections between elements are discussed in the following description. It is noted that these connections are general and, unless specified otherwise, may be direct or indirect, wired or wireless, and that the specification is not intended to be limiting in this respect.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As discussed above, current financial transaction processing methods and current financial transaction analyses might not permit enterprise organizations to deconstruct an asset into a plurality of components, generate an NFT (and/or a decomposed NFT) that corresponds to each asset and/or each component therein, detect an appreciation and/or depreciation of the value of the asset based on monitoring the NFT (and/or decomposed NFTs) associated with each component, and/or evaluate additional consumer requests based on analyzing a totality of NFTs associated with a consumer computing device. Accordingly, proposed herein is a solution to the problem described above that includes evaluating transactions in a decentralized finance network based on decomposed non-fungible tokens (NFTs). For example, an enterprise organization computing device may receive, from a consumer computing device, a request to acquire ownership (e.g., purchase, or the like) an asset. The enterprise organization computing device may transmit the consumer request to a computing platform along with instructions to analyze the consumer request. The computing platform may analyze the consumer request and may generate, based on the analysis, a recommendation indicating whether the enterprise organization computing device should approve or reject the consumer request. The enterprise organization computing device may use the recommendation from the computing platform to determine whether to approve or reject the consumer request. Based on rejecting the consumer request, the enterprise organization computing device may transmit a notification indicating rejection to the consumer computing device. Based on approving the consumer request, the enterprise organization computing device may transmit a notification indicating approval to the consumer computing device, and may instruct the computing platform to generate an NFT that correspond to the asset indicated in the consumer request.

The enterprise organization computing device may instruct an asset assessor computing device to assess (e.g., inspect, or the like) the asset indicated in the consumer request and may receive, from the asset assessor computing device, an assessment of the asset. The enterprise organization computing device may instruct the computing platform to analyze the assessment of the asset and to generate, based on the analysis, a plurality of decomposed NFTs that may correspond to a plurality of components associated with the asset. The computing platform may determine a value of the asset based on further analyzing the plurality of NFTs and the plurality of decomposed NFTs. The computing platform may generate a digital marketplace within which the NFTs and the decomposed NFTs may be traded and/or transferred. The computing platform may query the digital marketplace to generate consumer data and may use the consumer data to evaluate additional consumer requests.

### Computer Architecture

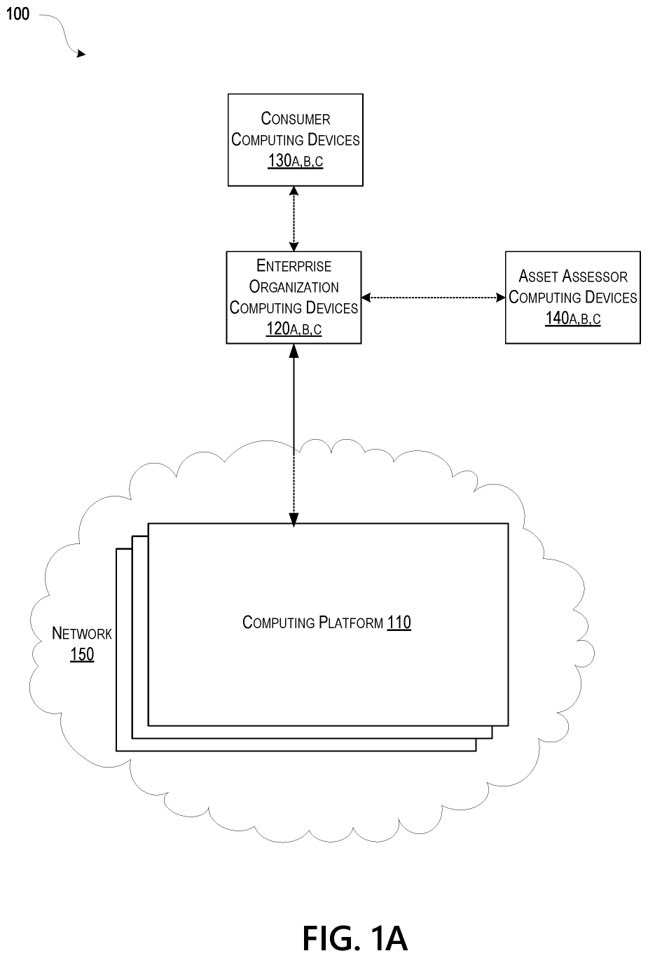

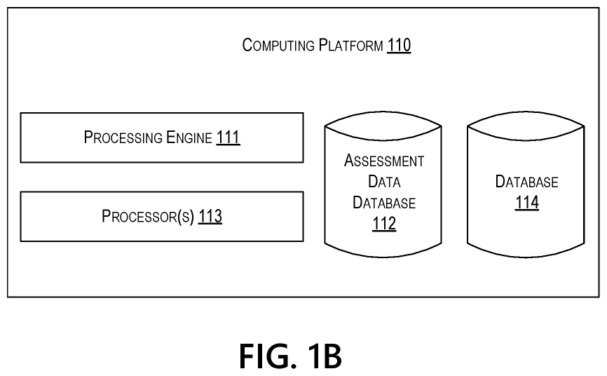

FIG. 1A depicts an illustrative example of a computer system that may be used for evaluating, in real-time or near real-time, transactions in a decentralized finance network based on decomposed non-fungible tokens (NFTs), in accordance with one or more aspects described herein. Computer system 100 may comprise one or more computing devices including at least computing platform 110, enterprise organization computing devices 120a-120c, consumer computing devices 130a-130c, and/or asset assessor computing devices 140a-140c.

While FIG. 1A comprises more than one enterprise organization computing device (e.g., enterprise organization computing devices 120a-120c), consumer computing device (e.g., consumer computing devices 130a-130c) and asset assessor computing device (e.g., asset assessor computing devices 140a-140c), each enterprise organization computing device, consumer computing device, and asset assessor computing device may be configured in accordance with the features described herein. While the description herein may refer to enterprise organization computing device 120, consumer computing device 130, and asset assessor computing device 140, the functions described in connection with enterprise organization computing device 120, consumer computing device 130, asset assessor computing device 140 may also be performed by any one of enterprise organization computing devices 120a-120c, consumer computing devices 130a-130c, and asset assessor computing devices 140a-140c. While FIG. 1A depicts enterprise organization computing devices 120a-120c, consumer computing devices 130a-130c, and asset assessor computing device 140a-140c, more or fewer enterprise organization computing devices, consumer computing devices, and/or asset assessor computing devices may exist within computer system 100. Enterprise organization computing devices 120a-120c, consumer computing devices 130a-130c, and asset assessor computing devices 140a-140c are depicted in FIG. 1A for illustration purposes only and are not meant to be limiting.

Computer system 100 may facilitate communication between the computing devices therein. Enterprise organization computing device 120 may communicate with consumer computing device 130 and/or asset assessor computing device 140 through network 150. Network 150 may include one or more sub-networks (e.g., local area networks (LANs), wide area networks (WANs), or the like). Enterprise organization computing device 120 may be configured to communicate with computing platform 110, and the computing devices therein, via network 150. In some arrangements, computer system 100 may include additional computing devices and networks that are not depicted in FIG. 1A, which may also be configured to interact with at least computing platform 110, enterprise organization computing device 120, consumer computing device 130, and/or asset assessor computing device 140.

Computing platform 110 may be associated with a distinct entity such as an enterprise organization, company, school, government, and the like, and may comprise one or more personal computer(s), server computer(s), hand-held or laptop device(s), multiprocessor system(s), microprocessor-based system(s), set top box(es), programmable user electronic device(s), network personal computer(s) (PC), minicomputer(s), mainframe computer(s), distributed computing environment(s), and the like. Computing platform 110 may include computing hardware and software that may host various data and applications for performing tasks of the centralized entity and interacting with enterprise organization computing device 120, and/or additional computing devices.

In some arrangements, computing platform 110 may include and/or be part of enterprise information technology infrastructure and may host a plurality of enterprise applications, enterprise databases, and/or other enterprise resources. Such applications may be executed on one or more computing devices included in computing platform 110 using distributed computing technology and/or the like. In some instances, computing platform 110 may include a relatively large number of servers that may support operations of the enterprise organization, such as a financial institution. Computing platform 110, in this embodiment, may generate a single centralized ledger, which may be stored in a database (e.g., database 114), for data received from at least one of enterprise organization computing device 120, consumer computing device 130, and/or asset assessor computing device 140.

Enterprise organization computing device 120 may be configured to receive and transmit information corresponding to requests through particular channels and/or applications associated with computing platform 110. The requests submitted by enterprise organization computing device 120 may initiate the performance of particular computational functions at computing platform 110.

Enterprise organization computing device 120 may receive, from a consumer computing device (e.g., consumer computing device 130), a consumer request to initiate a transaction with the enterprise organization (e.g., a request to acquire ownership of an asset, a request for financing that may be used to purchase the asset, or the like). Enterprise organization computing device 120 may instruct a processing engine (e.g., processing engine 111 of computing platform 110) to analyze the consumer request and may receive, from the processing engine, a recommendation on whether to approve or reject the consumer request. In some instances, enterprise organization computing device 120 may reject the consumer request and may transmit, to the consumer computing device, a notification indicating rejection of the consumer request. Alternatively, enterprise organization computing device 120 may approve the consumer request and may transmit, to the consumer computing device, a notification indication approval of the consumer request. Based on approving the consumer request, enterprise organization computing device 120 may instruct the processing engine to generate an NFT that corresponds to the asset and may instruct an asset assessor (e.g., asset assessor computing device 140) to assess the asset. Enterprise organization computing device 120 may instruct the processing engine to analyze the assessment of the asset.

Consumer computing device 130 may generate a request to initiate a transaction with the enterprise organization (e.g., a request to acquire ownership of the asset, a request for financing that may be used to purchase the asset, or the like) and may transmit the request to the enterprise organization computing device. Consumer computing device 130 may receive, from the enterprise organization computing device, a notification indicating one of approval of the consumer request or rejection of the consumer request.

Asset assessor computing device 140 may receive, from the enterprise organization computing device, instructions to assess (e.g., inspect, or the like) the asset indicated in the consumer request and may generate an assessment of the asset. Asset assessor computing device 140 may transmit the assessment to the enterprise organization computing device.

FIG. 1B depicts example components of a computing platform that may be used for evaluating, in real-time or near real-time, transactions in a decentralized finance network based on decomposed non-fungible tokens (NFTs), in accordance with one or more aspects described herein. Computing platform 110 may comprise processing engine 111, assessment data database 112, processor(s) 113, and/or database 114. Each computing device within computing platform 110 may contain processor(s) 113 and/or database 114, which may be stored in the memory of the one or more computing devices of computing platform 110. Through execution of computer-readable instructions stored in memory, the computing devices of computing platform 110 may be configured to perform functions of the centralized entity and store the data generated during the performance of such functions in database 114.

Processing engine 111 may receive, from the enterprise organization computing device, instructions to analyze the consumer request. Processing engine 111 may analyze the consumer request and may generate, based on the analysis, a recommendation on whether to approve or reject the consumer request. Processing engine 111 may receive, from the enterprise organization computing device, instructions to generate an NFT that may correspond to the asset indicated in the consumer request and may generate the NFT. Processing engine 111 may analyze the assessment of the asset to identify components of the asset and may generate a plurality of decomposed NFTs that may correspond to the components of the asset. Processing engine 111 may determine a value of the asset and may generate a digital marketplace within which the NFTs and the decomposed NFTs may be traded and/or transferred. Processing engine 111 may query the digital marketplace to generate data associated with the consumer computing device, and may use the generated consumer data to evaluate additional consumer requests.

Assessment data database 112 may comprise data that corresponds to each consumer request, each consumer computing device (e.g., consumer computing devices 130a-130c) that may generate and transmit a consumer request, and/or each analysis of each consumer request. Assessment data database 112 may comprise a copy of each received consumer request, details that describe the asset indicated in the consumer request (e.g., an indication of whether the asset corresponds to at least one of a property, a personal effect, or the like), and/or details that describe consumer computing device 130 (e.g., a credit score associated with consumer computing device 130, a credit history associated with consumer computing device 130, an account balance associated with consumer computing device 130, an employment history associated with consumer computing device 130, or the like).

Assessment data database 112 may comprise a risk score that corresponds to consumer computing device 130 and/or a determination (e.g., based on the risk score, or the like) of whether the consumer request was approved or rejected. Furthermore, assessment data database 112 may comprise a value determination model that may be used to determine a value of the asset, NFTs and decomposed NFTs that correspond to the asset, an assessment of the asset, and/or consumer data (e.g., that may be used to evaluate additional consumer requests, or the like). Assessment data database 112 may store dynamic data (e.g., the data may be continuously updated based on detecting at least one modification to the data, or the like). Assessment data database 112 may further store a log indicating previously generated data.

Access to assessment data database 112 may depend on the computing device requesting access (e.g., a hierarchy of accessibility). Processing engine 111 and enterprise organization computing device 120 may be associated with a first level of accessibility (e.g., a least restrictive level of accessibility). As such, processing engine 111 and enterprise organization computing device 120 may be authorized to perform functions on the data within assessment data database 112 (e.g., access data, add data, remove data, modify data, or the like). The remaining computing devices may be associated with a second level of accessibility (e.g., a more restrictive level of accessibility that the first level of accessibility). As such, the remaining computing devices may be configured to view the data, but might not be permitted to add, remove, and/or modify the data within assessment data database 112.

### Evaluating Transactions in a Decentralized Finance Network Based on Decomposed Non-Fungible Tokens (NFTs)

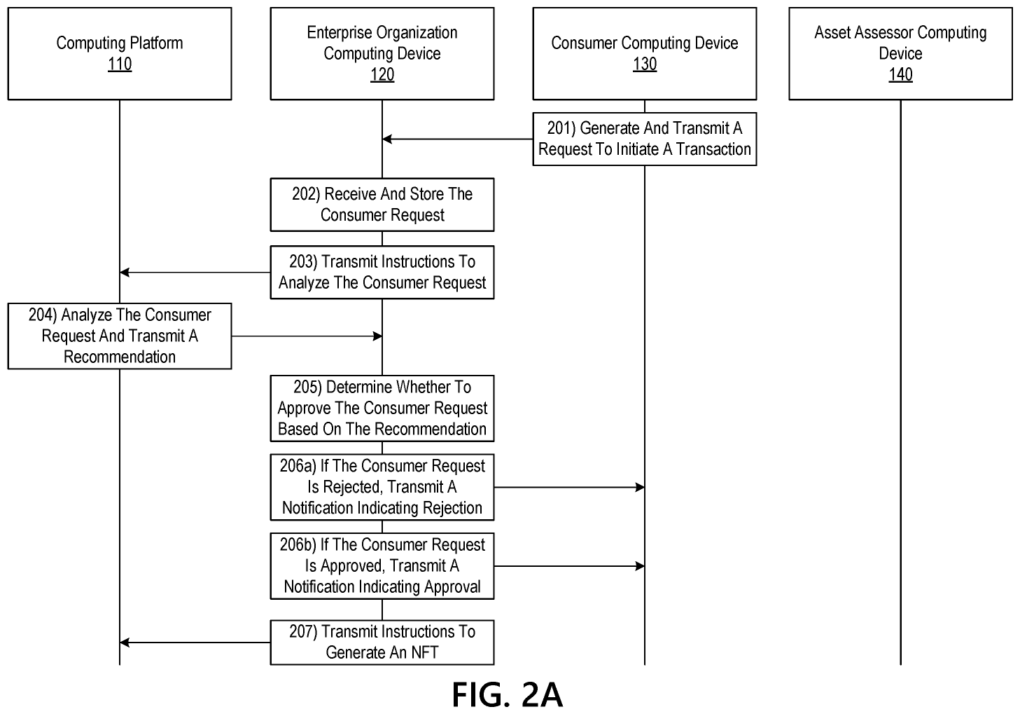

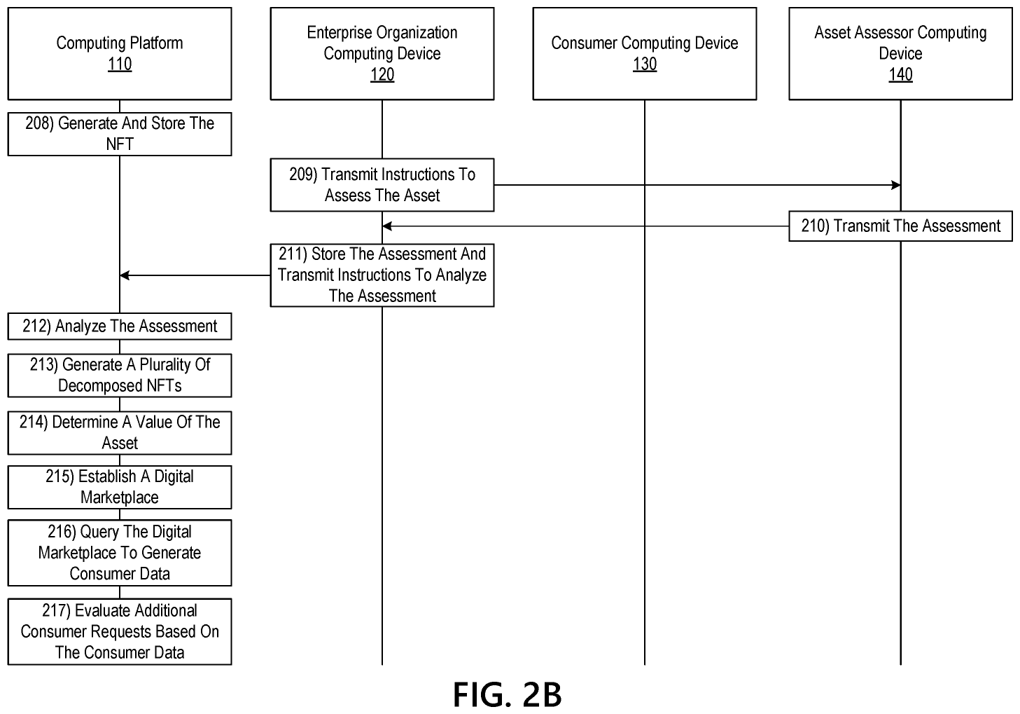

FIGS. 2A-2B depict an illustrative event sequence for evaluating, in real-time or near real-time, transactions in a decentralized finance network based on decomposed non-fungible tokens (NFTs), in accordance with one or more aspects described herein. While aspects described with respect to FIGS. 2A-2B include the evaluation of a single consumer request to initiate a transaction with the enterprise organization (e.g., a consumer request for financing to purchase an asset, or the like), a plurality of consumer requests may be received and evaluated (e.g., in parallel) without departing from the present disclosure. One or more processes performed in FIGS. 2A-2B may be performed in real-time or near real-time and one or more steps or processes may be added, omitted, or performed in a different order without departing from the present disclosure.

Referring to FIG. 2A, at step 201, consumer computing device 130 may generate a request to initiate a transaction with the enterprise organization (e.g., a request to acquire ownership of at least one asset, a request for financing to purchase the at least one asset, or the like). The consumer request may indicate the at least one asset (e.g., a commercial property, a residential property, an industrial property, a personal effect, or the like). Consumer computing device 130 may transmit the consumer request to enterprise organization computing device 120 via network 150.

At step 202, enterprise organization computing device 120 may receive the consumer request from consumer computing device 130 and may store the consumer request within assessment data database 112.

At step 203, enterprise organization computing device 120 may transmit, to processing engine 111 of computing platform 110, the consumer request and instructions to analyze the consumer request. In particular, enterprise organization computing device 120 may instruct processing engine 111 to extract details associated with consumer computing device 130, analyze the details associated with consumer computing device 130, and/or generate, based on the analysis of the details, a recommendation on whether to approve or reject the consumer request.

At step 204, processing engine 111 may receive, from enterprise organization computing device 120, the consumer request and the instructions to analyze the consumer request. Processing engine 111 may parse the consumer request to extract details that describe consumer computing device 130 (e.g., a credit score associated with consumer computing device 130, a credit history associated with consumer computing device 130, an account balance associated with consumer computing device 130, an employment history associated with consumer computing device 130, or the like), and may store the details within assessment data database 112. Processing engine 111 may use the extracted details to determine a likelihood of success that corresponds to the consumer request (e.g., a likelihood of consumer computing device 130 successfully repaying the financing received from the enterprise organization based on at least the credit score associated with consumer computing device 130, the credit history associated with consumer computing device 130, the account balance associated with consumer computing device 130, the employment history associated with consumer computing device 130, or the like).

Processing engine 111 may determine weighted values associated with the extracted consumer details using consumer criteria that may be generated by the enterprise organization. The consumer criteria may indicate a weight that corresponds to each consumer detail that may be extracted from the consumer request. The consumer criteria may also comprise instructions for determining a risk score that corresponds to the consumer request and/or instructions for analyzing the risk score. Processing engine 111 may use the weights indicated in the consumer criteria to determine a weighted value for each extracted consumer detail. Processing engine 111 may also use the instructions within the consumer criteria to combine the weighted values and generate the risk score.

The risk score may indicate a likelihood of approval of the consumer request. The risk score may correspond to a risk assessment threshold which may indicate a range of risk scores and/or corresponding likelihoods of approval. The risk assessment threshold may comprise a risk threshold value, which may correspond to the minimum risk score that may be needed for approval of the consumer request. The instructions may further indicate that consumer requests associated with risk scores equal to or greater than the risk threshold value may be approved, whereas consumer requests associated with risk scores less than the risk threshold value may be rejected. Processing engine 111 may store the risk score within assessment data database 112.

Processing engine 111 may analyze the risk score to generate the recommendation on whether the consumer request should be approved or rejected. In instances where the risk score is equal to or greater than the risk threshold value, processing engine 111 may recommend that the consumer request be approved. Alternatively, in instances where the risk score is less than the risk threshold value, processing engine 111 may recommend that the consumer request be rejected. Processing engine 111 may transmit the recommendation to enterprise organization computing device 120.

At step 205, enterprise organization computing device 120 may receive the recommendation from processing engine 111, and may determine whether to approve or reject the consumer request based on the recommendation. In some instances, enterprise organization computing device 120 may reject the consumer request based on parsing the recommendation and/or determining that the recommendation indicates the consumer request should be rejected. Additionally or alternatively, enterprise organization computing device 120 may approve the consumer request based on the parsing and/or determining that the recommendation indicates the consumer request should be approved.

If, at step 205, enterprise organization computing device 120 determines that the consumer request should be rejected, then, at step 206a, enterprise organization computing device 120 may transmit, to consumer computing device 130, a notification indicating rejection of the consumer request.

Alternatively, if, at step 205, enterprise organization computing device 120 determines that the consumer request should be approved, then, at step 206b, enterprise organization computing device 120 may transmit, to consumer computing device 130, a notification indicating approval of the consumer request.

At step 207, enterprise organization computing device 120 may transmit, to processing engine 111 and based on approving the consumer request, instructions to generate a digital rendering of the consumer request and/or the asset indicated in the consumer request. In some instances, the digital rendering may correspond to a non-fungible token (NFT). The generation of the NFT may link ownership of the asset to consumer computing device 130 and, as discussed below, may streamline at least one of a process to transfer and/or acquire ownership (e.g., partial ownership, or the like) of the asset.

Referring to FIG. 2B and at step 208, processing engine 111 may generate the NFT that corresponds to the asset indicated in the consumer request. In some instances, processing engine 111 may store the NFT that corresponds to an asset in assessment data database 112. However, as discussed below, processing engine 111 may also store the NFT within a digital marketplace that may be generated using the decentralized finance network. A structure of the decentralized finance network may permit communication and/or collaboration between entities associated with the decentralized finance network (e.g., enterprise organization computing device 120, consumer computing device 130, asset assessor computing device 140, or the like). Within the decentralized finance network, the communication and/or collaboration between the entities might not be routed through a central computing device and/or a central entity (e.g., might not be routed through enterprise organization computing device 120, the enterprise organization, or the like). As such, processes that correspond to transferring and/or trading the NFTs might not require interaction with enterprise organization computing device 120 and/or the enterprise organization.

At step 209, enterprise organization computing device 120 may transmit, to asset assessor computing device 140, instructions to assess the asset indicated in the consumer request. In particular, enterprise organization computing device 120 may instruct asset assessor computing device 140 to inspect the asset (e.g., conduct a manual inspection of a physical asset, or the like) to generate a description of the asset and/or to identify a plurality of components of the asset.

In some instances, enterprise organization computing device 120 may receive, from consumer computing device 130, an indication that at least one feature of the asset indicated in the consumer request was modified. Based on receiving the indication, enterprise organization computing device 120 may transmit, to asset assessor computing device 140, instructions to assess the asset and/or the modifications to the at least one feature of the asset. Enterprise organization computing device 120 may continuously transmit, to asset assessor computing device 140, instructions to generate an updated assessment of the asset.

At step 210, asset assessor computing device 140 may receive the instructions to assess the asset and may generate and transmit the assessment. The assessment of the asset may identify and describe the asset. The description of the asset may identify the plurality of components of the asset. To identify the plurality of components of the asset, asset assessor computing device 140 may decompose (e.g., deconstruct) the asset and may identify, based on the decomposition, the discrete components that make up the asset in its entirety. For example, where the asset is a residential property, the plurality of components may correspond to a residential structure on the property, lumber that may have been used to build the residential structure, personal effects within the residential structure, land beneath the residential structure, soil beneath the land, or the like. The assessment of the asset may further comprise details that describe that totality of the asset (e.g., a geographic location of a physical asset, a network location of a digital asset, comparable physical and/or digital assets, values associated with the comparable physical and/or digital assets, market projections of a value of the asset, projected conditions that may influence the market projections, or the like). Asset assessor computing device 140 may transmit the assessment to enterprise organization computing device 120.

At step 211, enterprise organization computing device 120 may receive and store the assessment, and may transmit, to processing engine 111, the assessment and instructions to analyze the assessment.

At step 212, processing engine 111 may receive, from enterprise organization computing device 120, the assessment and the instructions to analyze the assessment. Processing engine 111 may parse the assessment to identify the description of the entirety of the asset. Furthermore, processing engine 111 may parse the assessment to identify each component of the plurality of components of the asset as well a description of each component.

At step 213, processing engine 111 may generate a plurality of decomposed NFTs wherein each decomposed NFT may correspond to a component of the asset. To do so, processing engine 111 may parse assessment data database 112 to retrieve the NFT that may correspond to the asset. In some instances, and as discussed below, processing engine 111 may parse the digital marketplace (e.g., that may store a plurality of NFTs that may correspond to a plurality of assets indicated in a plurality of consumer requests, or the like) to retrieve the NFT that may correspond to the asset. Processing engine 111 may link each decomposed NFT that may correspond to each component of the asset to the NFT that may correspond to the asset, thereby generating a nested NFT structure. Processing engine 111 may store the plurality of decomposed NFTs within assessment data database 112 and/or the digital marketplace, as discussed below.

The generation of a decomposed NFT may link ownership of the component of the asset to consumer computing device 130 (and/or to a different computing device that may acquire ownership of a component of the asset) and, as discussed below, may streamline at least one of the processes of transferring and/or acquiring ownership (e.g., partial ownership, or the like) of the asset. Within the decentralized finance network, the processes that correspond to transferring and/or trading the decomposed NFTs might not require interaction with enterprise organization computing device 120 (or a central computing device) and/or the enterprise organization (or a central entity).

At step 214, processing engine 111 may determine a value of the asset. In some instances, processing engine 111 may determine the value of the asset based on the data within the assessment of the asset (e.g., a geographic location of a physical asset, a network location of a digital asset, comparable physical and/or digital assets, values associated with the comparable physical and/or digital assets, market projections of a value of the asset, projected conditions that may influence the market projections, or the like). Processing engine 111 may analyze market data and/or market projections within the assessment to identify at least one condition that may result in an appreciation (or depreciation) of the value of the asset (or a value associated with each component of the asset). Processing engine 111 may use the at least one condition to generate a value determination model. Processing engine 111 may continuously modify the value determination model based on receiving and analyzing an updated assessment of the asset. Additionally or alternatively, processing engine 111 may use the value determination model to determine a value of each component of the asset. Processing engine 111 may use the value of each component of the asset to determine the value of the asset in its entirety. Processing engine 111 may store the value of the asset and/or the value of each component of the asset within assessment data database 112 and/or the digital marketplace.

In some instances, processing engine 111 may use the determination of the value of the asset and/or the value of each component of the asset to determine whether to modify the recommendation to the approve the consumer request. To do so, processing engine 111 may monitor the value of the asset (and/or the value of each component of the asset) and may compare the value of the asset (and/or the value of each component of the asset) to the data that describes consumer computing device 130. Processing engine 111 may determine whether the data that describes consumer computing device 130 suggests that consumer computing device 130 may be prepared to handle fluctuations of the value of the asset (and/or the value of each component of the asset).

For example, processing engine 111 may detect, using the value determination model, that the value of the asset may have appreciated, and may determine whether consumer computing device 130 may successfully repay an increased financing total associated with the asset based on analyzing at least one of the credit score, the credit history, the account balance, or the employment history associated with consumer computing device 130. Based on determining consumer computing device 130 may successfully handle an increased financing total associated with the asset, processing engine 111 might not transmit, to enterprise organization computing device 120, a revised recommendation. Alternatively, based on determining consumer computing device 130 might not successfully handle the increased financing total associated with the asset, processing engine 111 may generate and transmit, to enterprise organization computing device 120, a revised recommendation based on the steps described above.

At step 215, processing engine 111 may generate the digital marketplace, within which computing devices associated with the decentralized finance network may transfer, trade, and/or acquire NFTs and/or decomposed NFTs associated with at least one asset of the plurality of assets. The digital marketplace may facilitate communication and/or collaboration between the computing devices associated with the decentralized finance network (e.g., enterprise organization computing device 120, consumer computing device 130, asset assessor computing device 140, or the like).

Communication and/or collaboration between the computing devices may be conducted independently of a central computing device (e.g., enterprise organization computing device 120, or the like) and/or a central entity (e.g., the enterprise organization, or the like). As such, a computing device associated with the decentralized finance network may communicate directly with at least one other computing device associated with the decentralized finance network.

A portion of the digital marketplace may store the plurality of NFTs that correspond to a plurality of assets that the enterprise organization may finance and the plurality of decomposed NFTs that correspond to components of an asset of the plurality of assets. Each NFT of the plurality of NFTs and/or each decomposed NFT of the plurality of decomposed NFTs may comprise ownership details. In some instances, the ownership details may indicate a consumer computing device (e.g., consumer computing device 130) that may have complete and/or partial ownership of the asset.

The ownership of an asset may change from a first computing device to a second computing device and, similarly, the ownership of the NFT (or decomposed NFT) that corresponds to the asset may change from the first computing device to the second computing device. To do so, the NFT (or decomposed NFT) that corresponds to the asset may be set to null (e.g., destroyed, or the like) and a new NFT (or a new decomposed NFT) may be generated to indicate the updated ownership. In some instances, computing devices that might not be associated with the decentralized finance network may be permitted to access and/or interact within the digital marketplace based on acquiring an NFT (or decomposed NFT) (e.g., based on purchasing the asset associated with an existing NFT, based on purchasing and/or financing a component of the asset associated an existing NFT, or the like).

At step 216, processing engine 111 may generate consumer data associated with consumer computing device 130 based on querying the digital marketplace to gather details that describe assets associated with consumer computing device 130. To do so, processing engine 111 may access the portion of the digital marketplace that may store the plurality of NFTs that correspond to the plurality of assets and the plurality of decomposed NFTs that correspond to components of the assets within the plurality of assets. Processing engine 111 may parse the stored plurality of NFTs to identify a subset of the plurality of NFTs that may correspond to assets that consumer computing device 130 may own (e.g., based on parsing ownership details associated with the plurality of NFTs, or the like). Processing engine 111 may also parse the stored plurality of decomposed NFTs to identify a subset of the plurality of decomposed NFTs that may correspond to components of assets, of the plurality of assets, that consumer computing device 130 may own (e.g., based on parsing ownership details associated with the plurality of decomposed NFTs, or the like).

Processing engine 111 may further parse the data stored within the digital marketplace to identify values that correspond to the assets associated with the subset of the plurality of NFTs and values that correspond to the components of the assets associated with the subset of the decomposed NFTs. Processing engine 111 may analyze a total value of assets and components of assets associated with consumer computing device 130, and generate consumer data that describes consumer computing device 130 (e.g., a net worth associated with consumer computing device 130 based on the total value of assets and components of assets, or the like). Processing engine 111 may store, within the digital marketplace and assessment data database 112, the net worth associated with consumer computing device 130.

At step 217, processing engine 111 may use the consumer data (e.g., the net worth associated with consumer computing device 130, or the like) to evaluate additional consumer requests. Based on receiving an additional consumer request from enterprise organization computing device 120, processing engine 111 may analyze the consumer data to generate a recommendation on whether to approve or reject the additional consumer request. Processing engine 111 may combine the details that describe consumer computing device 130 with the consumer data to determine at least one of a likelihood of default associated with consumer computing device 130, an indication of financial stability associated with consumer computing device, a purchase transaction history associated with consumer computing device 130, or the like.

Processing engine 111 may use the combination of details that describe consumer computing device 130 and the consumer data to evaluate the likelihood of success of the additional consumer request (e.g., the likelihood of consumer computing device 130 successfully repaying the financing received from the enterprise organization to acquire the at least one asset indicated in the additional consumer request, or the like). Processing engine 111 may continuously modify and/or update the consumer data and/or the details that describe consumer computing device 130 to generate a refined consumer request evaluation process that may be used for evaluating additional consumer requests.

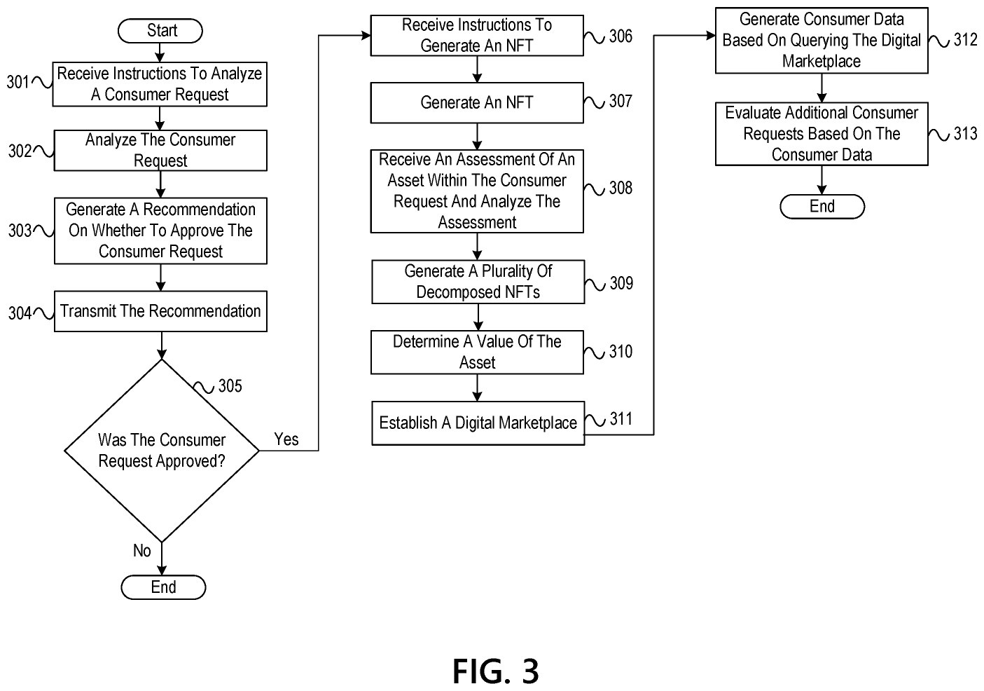

FIG. 3 depicts an illustrative event sequence for evaluating, in real-time or near real-time, transactions in a decentralized finance network based on decomposed non-fungible tokens (NFTs), in accordance with one or more aspects described herein. While aspects described with respect to FIG. 3 include the evaluation of a single consumer request, a plurality of consumer requests may be evaluated (e.g., in parallel) without departing from the present disclosure. One or more processes performed in FIG. 3 may be performed in real-time or near real-time and one or more steps or processes may be added, omitted, or performed in a different order without departing from the present disclosure.

At step 301, computing platform 110 (e.g., via processing engine 111) may receive, from enterprise organization computing device 120, a consumer request and instructions to analyze the consumer request.

At step 302, computing platform 110 (e.g., via processing engine 111) may analyze the consumer request. To do so, processing engine 111 may parse the consumer request to extract details that describe consumer computing device 130. Processing engine 111 may use the extracted details to determine a likelihood of success that corresponds to the consumer request. In particular, processing engine 111 may determine a risk score that may correspond to the consumer request and may indicate a likelihood of success of the consumer request. Processing engine 111 may determine weighted values associated with the extracted consumer details and may combine the weighted values to generate the risk score.

At step 303, computing platform 110 (e.g., via processing engine 111) may analyze the risk score to generate a recommendation on whether the consumer request should be approved or rejected. To do so, processing engine 111 may compare the risk score to the risk threshold value, which may correspond to the minimum risk score that may be needed for approval of the consumer request. Processing engine 111 may determine that risk scores equal to or greater than the risk threshold value should be approved, whereas consumer requests associated with risk scores less than the risk threshold value should be rejected.

At step 304, computing platform 110 (e.g., via processing engine 111) may transmit the recommendation to enterprise organization computing device 120.

At step 305, computing platform 110 (e.g., via processing engine 111) may determine whether enterprise organization computing device 120 approved the consumer request. If, at step 305, processing engine 111 determines that enterprise organization computing device 120 did not approve the consumer request (e.g., rejected the consumer request), then processing engine 111 may terminate the processing described herein and might not further analyze the consumer request.

Alternatively, if, at step 305, processing engine 111 determines that enterprise organization computing device 120 approved the consumer request, then, at step 306, computing platform 110 (e.g., via processing engine 111) may receive, from enterprise organization computing device 120, instructions to generate an NFT that corresponds to the asset indicated in the consumer request.

At step 307, computing platform 110 (e.g., via processing engine 111) may generate the NFT that corresponds to the asset indicated in the consumer request. Processing engine 111 may store the NFT that corresponds to asset in assessment data database 112. However, in some instances, processing engine 111 may also store the NFT within a digital marketplace that may be generated using the decentralized finance network.

At step 308, computing platform 110 (e.g., via processing engine 111) may receive, from enterprise organization computing device 120, an assessment of the asset indicated in the consumer request and may analyze the assessment. Processing engine 111 may parse the assessment to identify the description of the entirety of the asset. Furthermore, processing engine 111 may parse the assessment to identify each component of the plurality of components of the asset as well a description of each component.

At step 309, computing platform 110 (e.g., via processing engine 111) may generate a plurality of decomposed NFTs wherein each decomposed NFT may correspond to a component of the asset. Processing engine 111 may parse assessment data database 112 to retrieve the NFT that may correspond to the asset. Processing engine 111 may link each decomposed NFT that may correspond to each component of the asset to the NFT that may correspond to the asset, thereby generating a nested NFT structure.

At step 310, computing platform 110 (e.g., via processing engine 111) may determine a value of the asset based on the data within the assessment of the asset. Processing engine 111 may analyze market data and/or market projections within the assessment to identify at least one condition that may result in an appreciation (or depreciation) of the value of the asset (or a value associated with each component of the asset), and may use the at least one condition to generate a value determination model. In some instances, processing engine 111 may use the value determination model to determine a value of each component of the asset. Processing engine 111 may use the value of each component of the asset to determine the value of the asset in its entirety.

At step 311, computing platform 110 (e.g., via processing engine 111) may generate the digital marketplace, within which computing devices associated with the decentralized finance network may transfer, trade, and/or acquire NFTs and/or decomposed NFTs associated with at least one asset of the plurality of assets. The digital marketplace may facilitate communication and/or collaboration between the computing devices associated with the decentralized finance network. Communication and/or collaboration between the computing devices may be conducted independently of a central computing device and/or a central entity.

At step 312, computing platform 110 (e.g., via processing engine 111) may generate consumer data associated with consumer computing device 130 based on querying the digital marketplace to gather details that describe assets associated with consumer computing device 130. Processing engine 111 may access the portion of the digital marketplace that may store the plurality of NFTs that correspond to the plurality of assets and the plurality of decomposed NFTs that correspond to components of the assets within the plurality of assets. Processing engine 111 may identify a subset of the plurality of NFTs that may correspond to assets that consumer computing device 130 may own. Processing engine 111 may also identify a subset of the plurality of decomposed NFTs that may correspond to components of assets, of the plurality of assets, that consumer computing device 130 may own.

Processing engine 111 may further parse the data stored within the digital marketplace to identify values that correspond to the assets associated with the subset of the plurality of NFTs and values that correspond to the components of the assets associated with the subset of the decomposed NFTs. Processing engine 111 may analyze a total value of assets and components of assets associated with consumer computing device 130, and generate consumer data that describes consumer computing device 130.

At step 313, computing platform 110 (e.g., via processing engine 111) may use a combination of details that describe consumer computing device 130 and the generated consumer data to evaluate the likelihood of success of additional consumer requests.

As a result, the proposed solution may provide the following benefits: 1) real-time, or near real-time, generation of an NFT that may correspond to an asset indicated in a consumer request; 2) real-time, or near real-time, deconstruction and/or inspection of the asset to identify components of the asset; 3) real-time, or near real-time, generation of decomposed NFTs that correspond to, for an asset of the plurality of assets, components of the asset; 4) real-time, or near real-time, valuation of the asset and/or the components of the asset based on analyzing the NFTs and decomposed NFTs within a digital marketplace; and 5) real-time, or near real-time, generation of a consumer request evaluation process.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an enterprise computing platform, or as one or more non-transitory computer-readable media storing instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space).

As described herein, the various methods and acts may be operative across one or more computing servers and one or more networks. The functionality may be distributed in any manner, or may be located in a single computing device (e.g., a server, a user computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
at a computing device including one or more processors and memory:
receiving, from an enterprise organization computing device, a consumer request and instructions to analyze the consumer request;
analyzing the consumer request;
generating, based on the analyzing the consumer request, a recommendation on whether to approve the consumer request;
transmitting, to the enterprise organization computing device, the recommendation;
receiving, from the enterprise organization computing device, instructions to analyze an assessment of an asset, of a plurality of assets, associated with the consumer request;
analyzing, based on analyzing the assessment, a plurality of components of the asset;
generating a plurality of non-fungible tokens (NFTs), wherein each NFT corresponds to a different asset of the plurality of assets;
generating a plurality of decomposed NFTs, wherein each decomposed NFT corresponds to, for each asset of the plurality of assets, a different component of the plurality of components of the asset;
determining, based on analyzing the plurality of components of the asset, a value of the asset;
determining, based on the value of the asset, consumer data that corresponds to a consumer computing device associated with the consumer request; and
evaluating a plurality of additional consumer requests, associated with the consumer computing device, based on the consumer data.

2. The method of claim 1, wherein the consumer request comprises a request to acquire ownership of the asset, wherein the asset may correspond to at least one of:
a property, wherein the property corresponds to at least one of:
a commercial property,
a residential property, or
an industrial property; or
a personal effect associated with the consumer computing device.

3. The method of claim 1, wherein the analyzing the consumer request further comprises:
parsing the consumer request;
identifying, based on the parsing, the consumer computing device associated with the consumer request; and
determining at least one of:
a credit score associated with the consumer computing device,
a credit history associated with the consumer computing device,
an account balance associated with the consumer computing device, or
an employment history associated with the consumer computing device.

4. The method of claim 3, further comprising:
determining a risk score that corresponds to consumer computing device, wherein the determining the risk score further comprises assigning a weight to at least one of:
the credit score,
the credit history,
the account balance, or
the employment history; and
comparing the risk score to a risk threshold value, wherein the risk threshold value indicates a minimum risk score needed to approve the consumer request.

5. The method of claim 4, wherein the recommendation comprises one of:
a determination that the consumer request should be rejected based on determining that the risk score that corresponds to the consumer computing device is less than the risk threshold value; or
a determination that the consumer request should be approved based on determining that the risk score that corresponds to the consumer computing device is equal to or greater than the risk threshold value.

6. The method of claim 1, wherein the assessment of the asset may comprise at least one of:
an identification of the asset;
an identification of each component of the plurality of components of the asset; and
a description of each component of the plurality of components of the asset.

7. The method of claim 1, wherein the determining the value of the asset further comprises determining a value associated with each component of the asset.

8. The method of claim 7, wherein the determining the value associated with each component of the asset further comprises generating a value determination model, wherein the value determination model may predict at least one of:
appreciation of the value associated with each component of the asset,
appreciation of the value of the asset,
depreciation of the value associated with each component of the asset, or
depreciation of the value of the asset.

9. The method of claim 8, further comprising establishing a digital marketplace within which the consumer computing device can transfer ownership of the asset based on transferring at least one of:
an NFT, of the plurality of NFTs, that corresponds to the asset; or
a decomposed NFT, of the plurality of decomposed NFTs, that corresponds to a component of the asset.

10. The method of claim 9, wherein the determining the consumer data that corresponds to the consumer computing device further comprises:
querying the digital marketplace;
identifying, based on the querying, a subset of the plurality of NFTs, wherein each NFT of the subset of the plurality of NFTs corresponds to an asset, of the plurality of assets, that the consumer computing device owns; and
identifying, based on the querying, a subset of the plurality of decomposed NFTs, wherein each decomposed NFT of the subset of the plurality of decomposed NFTs corresponds to a component of the asset, of the plurality of assets, that the consumer computing device owns; and
determining, based on the identifying the subset of the plurality of NFTs and the subset of the plurality of decomposed NFTs, a net worth that corresponds to the consumer computing device.

11. The method of claim 10, wherein the net worth that corresponds to the consumer computing device may indicate a total value of the subset of the plurality of NFTs.

12. The method of claim 11, wherein the analyzing the consumer request further comprises analyzing the net worth that corresponds to the consumer computing device.

13. The method of claim 12, wherein the evaluating the plurality of additional consumer requests further comprises determining, based on the analyzing the consumer request, details that describe the consumer computing device, wherein the details may correspond to at least one of:
a likelihood of default associated with the consumer computing device;
an indication of financial stability associated with the consumer computing device; or
a purchase transaction history associated with the consumer computing device.

14. A computing platform comprising:
at least one processor;
a communication interface communicatively coupled to the at least one processor; and
memory storing computer-readable instructions that, when executed by the at least one processor, cause the computing platform to:
receive, from an enterprise organization computing device, a consumer request and instructions to analyze the consumer request;
analyze the consumer request;
generate, based on the analyzing the consumer request, a recommendation on whether to approve the consumer request;
transmit, to the enterprise organization computing device, the recommendation;
receive, from the enterprise organization computing device, instructions to analyze an assessment of an asset, of a plurality of assets, associated with the consumer request;
analyze, based on analyzing the assessment, a plurality of components of the asset;
generate a plurality of non-fungible tokens (NFTs), wherein each NFT corresponds to a different asset of the plurality of assets;
generate a plurality of decomposed NFTs, wherein each decomposed NFT corresponds to, for each asset of the plurality of assets, a different component of the plurality of components of the asset;
determine, based on analyzing the plurality of components of the asset, a value of the asset;
determine, based on the value of the asset, consumer data that corresponds to a consumer computing device associated with the consumer request; and
evaluate a plurality of additional consumer requests, associated with the consumer computing device, based on the consumer data.

15. The computing platform of claim 14, wherein the analyzing the consumer request further causes the computing platform to:
parse the consumer request;
identify, based on the parsing, the consumer computing device associated with the consumer request; and
determine at least one of:
a credit score associated with the consumer computing device,
a credit history associated with the consumer computing device,
an account balance associated with the consumer computing device, or
an employment history associated with the consumer computing device.

16. The computing platform of claim 15, wherein the computing platform is further configured to:
determine a risk score that corresponds to consumer computing device, wherein the determining the risk score further comprises assigning a weight to at least one of:
the credit score,
the credit history,
the account balance, or
the employment history; and
compare the risk score to a risk threshold value, wherein the risk threshold value indicates a minimum risk score needed to approve the consumer request.

17. The computing platform of claim 16, wherein the recommendation comprises one of:
a determination that the consumer request should be approved based on determining that the risk score that corresponds to the consumer computing device is less than the risk threshold value; or
a determination that the consumer request should be rejected based on determining that the risk score that corresponds to the consumer computing device is equal to or greater than the risk threshold value.

18. One or more non-transitory computer-readable media storing instructions that, when executed by a computing platform comprising at least one processor, memory, and a communication interface, cause the computing platform to:
receive, from an enterprise organization computing device, a consumer request and instructions to analyze the consumer request;
analyze the consumer request;
generate, based on the analyzing the consumer request, a recommendation on whether to approve the consumer request;
transmit, to the enterprise organization computing device, the recommendation;
receive, from the enterprise organization computing device, instructions to analyze an assessment of an asset, of a plurality of assets, associated with the consumer request;
analyze, based on analyzing the assessment, a plurality of components of the asset;
generate a plurality of non-fungible tokens (NFTs), wherein each NFT corresponds to a different asset of the plurality of assets;
generate a plurality of decomposed NFTs, wherein each decomposed NFT corresponds to, for each asset of the plurality of assets, a different component of the plurality of components of the asset;
determine, based on analyzing the plurality of components of the asset, a value of the asset;
determine, based on the value of the asset, consumer data that corresponds to a consumer computing device associated with the consumer request; and
evaluate a plurality of additional consumer requests, associated with the consumer computing device, based on the consumer data.

19. The non-transitory computer-readable media of claim 18, wherein the consumer request comprises a request to acquire ownership of the asset, wherein the asset may correspond to at least one of:
a property, wherein the property corresponds to at least one of:
a commercial property,
a residential property, or
an industrial property; or
a personal effect associated with the consumer computing device.

20. The non-transitory computer-readable media of claim 18, wherein the analyzing the consumer request further cause the computing platform to:
parse the consumer request;
identify, based on the parsing, the consumer computing device associated with the consumer request; and
determine at least one of:
a credit score associated with the consumer computing device,
a credit history associated with the consumer computing device,
an account balance associated with the consumer computing device, or
an employment history associated with the consumer computing device.
